(19) United States
(12) Patent Application Publication
(10) Pub. No.: US 2009/0049959 A1
(43) Pub. Date: Feb. 26, 2009

(54) Impact tool adapter for holding a socket

(76) Inventor: Terry Gibbs, Mineral Bluff, GA (US)

Correspondence Address: CLIFFORD H. KRAFT, 320 ROBIN HILL DR., NAPERVILLE, IL, 60540, US

(21) Appl. No.: 12/229,313

(22) Filed: Aug. 21, 2008

Related U.S. Application Data
(60) Provisional application No. 60/966,102, filed on Aug. 25, 2007.

(51) Int. Cl. B25B 13/58; B25B 13/06

(52) U.S. Cl. 81/180.1; 81/121.1

(57) ABSTRACT

An adapter for an impact tool that securely holds a standard size socket. This adapter can be similar to a drill chuck and contain a locking mechanism to hold a socket. The adapter can be made to slip onto the impact tool just like any other tip or adapter. The adapter locks on the end of the impact tool. The socket receiving end resembles the mechanism of a standard socket wrench. Instead of the ball found on many socket wrenches, the present invention can contain a depressable pin with a tip that inserts into the socket. An edge on the pin provides positive protection against fall off even under extreme shock loads. The adapter can be supplied with different sized shanks to fit standard socket insert sizes. The adapter can optionally be used as an extension and manufactured in different lengths.

This application is related to and claims priority from U.S. Provisional patent application No. 60/966,102 file Aug. 25, 2008. Application 60/966,102 is hereby incorporated by reference.

### BACKGROUND

1. Field of the Invention

The present invention relates generally to the field of impact tools and more particularly to an adapter for an impact tool that securely holds a removable socket.

2. Description of the Prior Art

Impact tools are known and used in numerous industrial areas including automobile maintenance by auto mechanics. These tools can be used with different types of heads for different purposes. In particular, an impact tool can be used to loosen or tighten bolts. A major problem encountered when using an impact tool with a socket is that the socket has a tendency to fall off because the severe shock imparted by the tool destroys the lock ring normally supplied with the tool in a very short period of time. Typically, every mechanic has the problem that after 24 weeks of heavy use, the lock ring reaches a condition where the socket continually falls off.

It would be advantageous to have a socket adapter for an impact tool that could replace the prior art lock ring system currently in use and provide a locking property to prevent fall-off of the socket under all normal impact loads without wearing out.

### SUMMARY OF THE INVENTION

The present invention relates to an adapter for an impact tool that takes a socket of one (or more) of the standard sizes. This adapter can be similar to a drill chuck and contain a locking mechanism to hold a socket. The adapter can be made to slip onto the impact tool just like any other tip or adapter. The adapter locks on the end of the impact tool. The socket receiving end resembles the mechanism of a standard socket wrench. Instead of the attach found on many socket wrenches, the present invention can contain a depressable pin with a tip that inserts into the socket. A edge on the pin provides positive protection against fall off even under extreme shock loads. The adapter can be supplied with different sized shanks to fit standard socket insert sizes such as ½ or ⅜. The adapter can optionally be used as an extension and manufactured in different lengths.

### DESCRIPTION OF THE FIGURES

Attention is now directed at several illustrations that aid in understanding the present invention:

FIG. 1 is a perspective view of an embodiment of the present invention.

FIG. 2A is a side view of the embodiment of FIG. 1.

FIG. 2B is a side view of a first embodiment showing internal parts.

FIG. 2C is a side view of a second embodiment showing internal parts.

FIG. 3A is a section of the embodiment of FIG. 2C which uses fingers to lock on to the impact tool.

FIG. 3B is a section of the embodiment of FIG. 2B which uses balls to lock on to the impact tool.

FIG. 4 is a perspective view of the embodiment of FIG. 3B showing internal parts.

FIG. 5 is an end view of the embodiment of FIG. 3A from the impact tool end showing internal parts including the balls.

FIG. 6 shows the tool of the present invention being used with an impact tool and socket.

FIG. 7 shows an alternate embodiment with a ring that engages the impact tool.

Several drawings and illustrations have been presented to aid in understanding the present invention. The present invention is not limited to what is shown in the figures.

### DESCRIPTION OF THE INVENTION

The present invention relates to an adapter for an impact tool that can securely hold a socket with a mechanism that is immune to the severe shock encountered during use of the impact tool. The adapter of the present invention is similar to a drill chuck and can fit on the end of a standard impact tool (usually by removing the lock ring supplied with the impact tool). The distal or far end of the adapter can contain a square tip that fits a standard socket. The adapter of the present invention can be supplied with different sized shanks to fit standard socket insert sizes such as ¼, ½, ¾, 1, ⅜, ⅝ inch or any size. Any insert size is within the scope of the present invention.

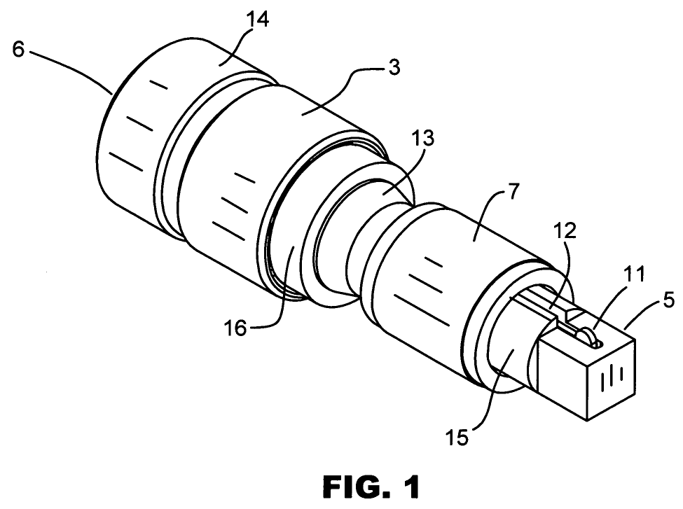

Turning to FIG. 1, a perspective view of an embodiment of the present invention can be seen. In this embodiment, the adapter has a rear or proximal end 6 that fits on to the end of the impact tool. A collar 3, 14 fits over a sleeve 16 on this end. The collar 14 can move forward to allow insertion of the tip of the impact tool and then move backward to lock the adapter on to the tool. In some embodiments, the collar 14 can be fixed, and the adapter simply snaps on to the impact tool. The adapter can engage the impact tool tip groove either using internal balls, internal fingers or an internal ring. Forward of the collar 14, 3, a sloping section 13 connects with the front of the tool 15 that contains the internal part of the socket mechanism. A second collar 7 can move on the front section 15 to allow locking and unlocking a socket. A square socket tip 5 is part of the front section 15. A groove 12 runs down the section 15 and up under the collar 7. A rocking pin mechanism 11 locks the socket onto the tip 5 of the tool.

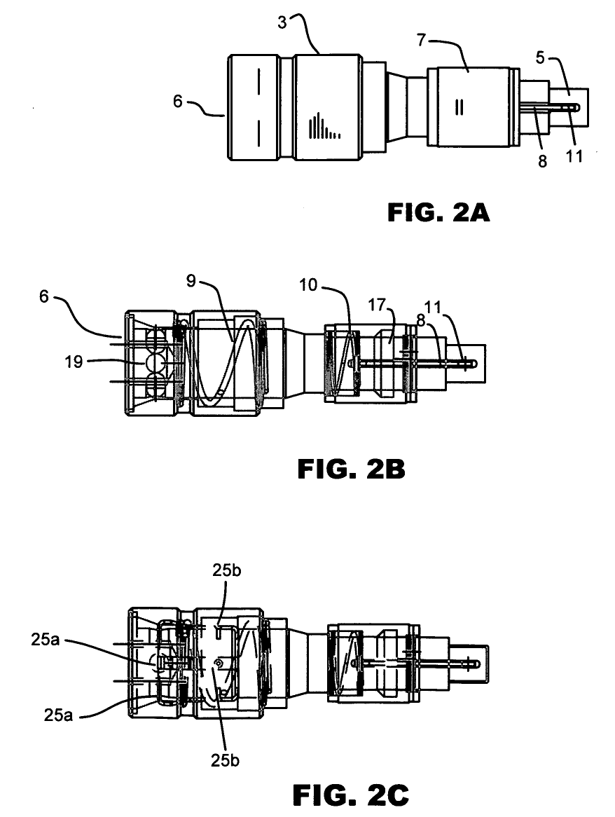

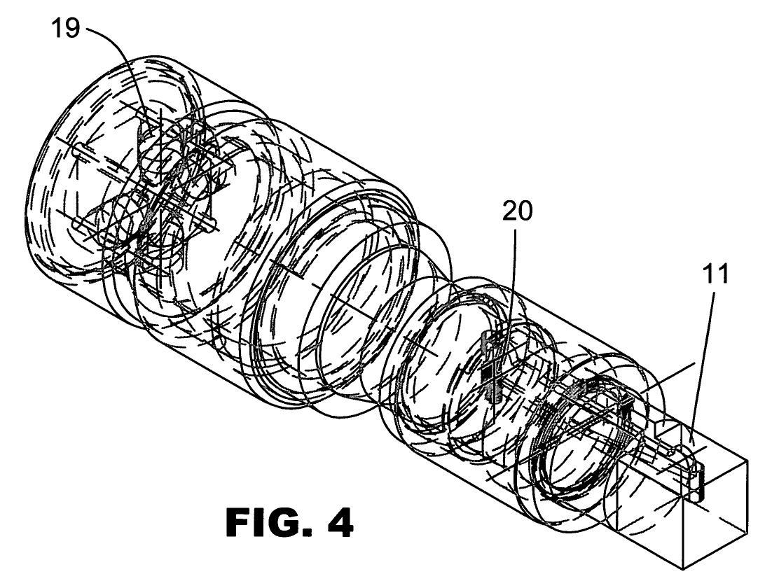

FIG. 2A shows a side view of the embodiment of FIG. 1. The socket pin 11 can be seen attached to a stem 8 that runs into the sleeve 7. FIG. 2B shows the an embodiment of the invention that locks onto the impact tool with balls 19. FIG. 2B also shows some internal parts. A front spring 10 is located behind a spacer 17. The collar 7 can slide aft against the front spring 10 to cause the pin 11 to depress. This action causes the adapter to release the socket as the pin 11 pulls downward. A small spring 20 (shown in FIG. 4) causes the pin 11 to depress when the collar 7 is slid backward. The embodiment of FIG. 2B uses balls 18, 19 to engage the impact tool groove. FIG. 2C shows an alternate embodiment of the impact locking mechanism where fingers 25a engage the groove in the impact tool. The forward ends of these fingers 25b are pushed downward when the collar 14, 3 is moved forward.

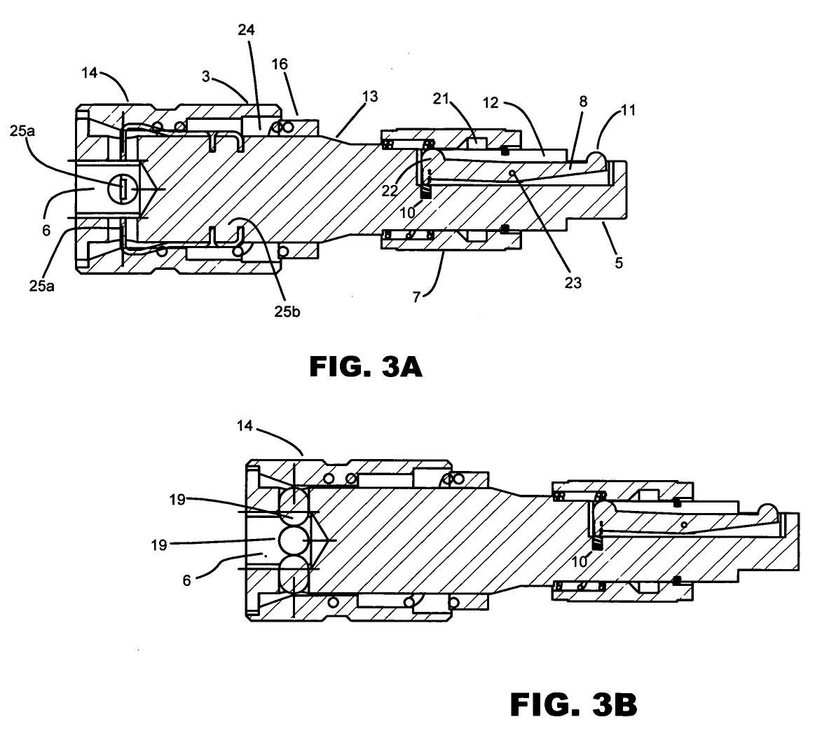

FIG. 3A is a section of the embodiment of FIG. 2C and shows how the stem 8 causes the pin 11 to depress when the collar 7 is slid backward. As the collar 7 slides backward, the groove 21 aligns with the rear tip 22 of the stem 8. The spring 10 causes the stem 8 to rocker about a pivot 23 so that the tip 11 pulls downward into the front of the tool 5 allowing the socket to release. When the collar 7 is moved forward, the rear tip 22 of the stem 8 is pushed down on spring 10 and the pivot about 23 cause the tip 11 to rise holding the socket secure.

FIGS. 3A and 3B show two different embodiments of the impact tool (proximal) end engaging mechanism. The embodiment in FIG. 3A uses either two, three or four (or more) fingers 25a, while the embodiment of FIG. 3B uses several spring-loaded steel balls 19 to lock into the existing groove on the impact tool. As the collar 3, 14 is move aft, an engage 24 pushes finger ends 25a away from the insert cavity 6 to release the impact tool by pushing on the other ends 25b. When the collar 14 is moved forward, the fingers 25a move down into the insert cavity 6 and positively engage the groove in the impact tool tip. While any number of fingers can be used, the preferred number is two or greater.

The spring-loaded steel balls 19 in FIG. 3B pull outward when the collar 3, 14 is moved forward along the sleeve 16, and lock into the impact tool tip groove when the collar 3, 14 is moved backward. While the preferred number of balls is four, any number may be used sufficient to positively engage the groove on the tip of the impact tool.

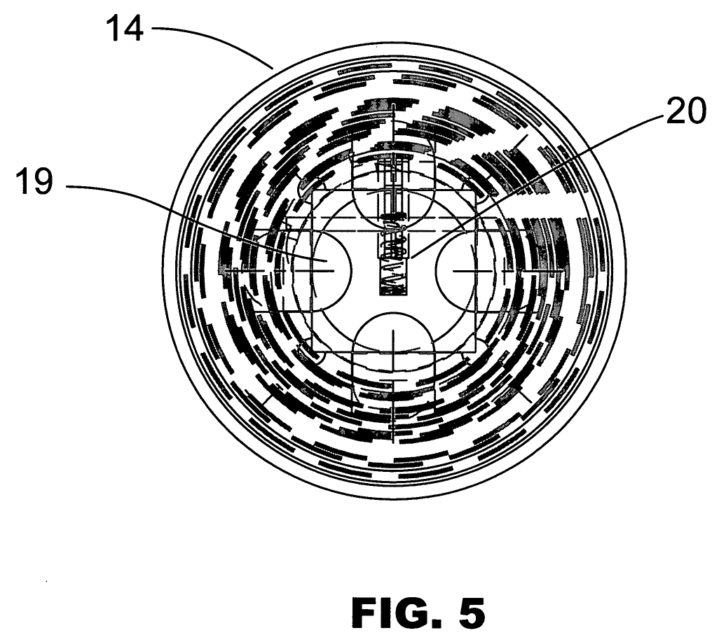

FIG. 4 shows a perspective view with internal parts of the embodiment of FIG. 3B. The balls 19 can be clearly seen. Also the front small spring 20 used to raise the tip 11 can be seen. FIG. 5 shows a rear view of this embodiment showing the balls 19 and the small spring 20.

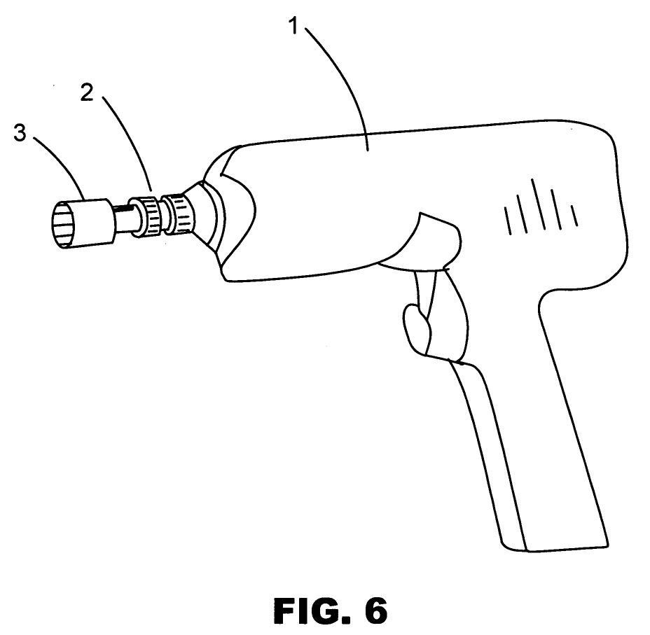

FIG. 6 shows a view of an impact tool 1 with the adapter of the present invention 2 mounted with a socket 3.

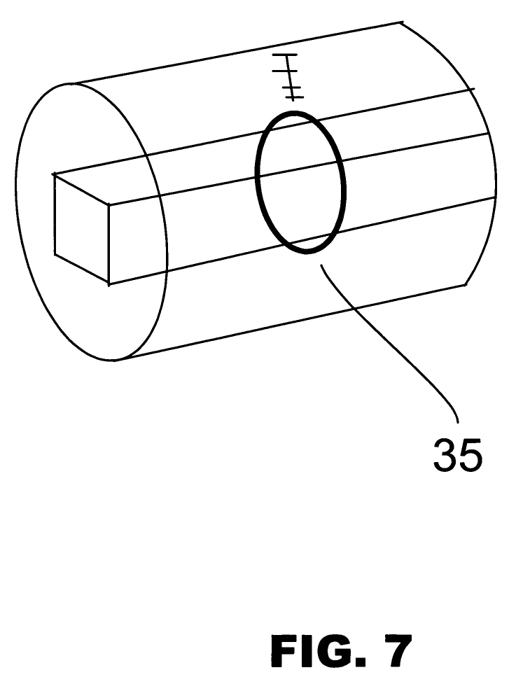

FIG. 7 shows an alternative way of mounting the tool of the present invention on the end of the impact tool using a ring 35 that can squeeze into the groove of the impact tool providing a positive grip. In this embodiment, the tip of the impact tool is inserted into the ring 35. A mechanism then causes the ring 35 to grip the tip of the tool.

It should be noted that the embodiments of the present invention resist wear caused by shock from said impact tool by having considerable mass and by not having a simple prior art ring that engages the socket. Rather, the present invention engages the impact tool with strong steel balls, each in a cylindrical steel cavity and engages the socket with a positive locking steel stem and tip. While other materials could be used besides steel if they are strong enough to withstand the shock from the impact tool, hardened steel is preferred.

Several descriptions and illustrations have been presented to aid in understanding the present invention. One skilled in the art will realize that numerous changes and variations are possible without departing from the spirit of the invention. Each of these changes and variations is within the scope of the present invention.

I claim:

1. An impact tool socket adapter comprising:
a first end containing an impact tool engagement adapted to securely engage on an impact tool;
a second end containing a socket engagement adapted to securely engage a socket;
wherein said impact tool, said adapter and said socket form a single coupled tool, and wherein said impact tool engagement and said socket engagement resist wear caused by shock from said impact tool.

2. The socket adapter of claim 1 wherein said impact tool engagement further comprises a collar with a plurality of spring-loaded balls which engage an impact tool tip.

3. The socket adapter of claim 1 wherein said impact tool engagement further comprises a collar with a plurality of fingers that engage and impact tool tip.

4. The socket adapter of claim 1 wherein said impact tool engagement further comprises a ring that engages an impact tool tip.

5. The socket adapter of claim 1 wherein said socket engagement further comprises a retractable engagement tip that positively engages said socket.

6. The socket adapter of claim 5 wherein said retractable engagement tip retracts upon sliding of a collar on a sleeve.

7. An impact tool socket adapter having a proximal and distal end comprising:
a cylindrical recess on said proximal end containing a plurality of steel balls or fingers that engage an impact tool tip groove;
a first collar that slides fore and aft over said cylindrical recess that causes said steel balls or fingers to engage and disengage said impact tool as it slides;
a socket engaging member on said distal end of said adapter containing a retracting tip that locks a socket on said socket engaging member in an extended position and releases said socket in a retracted position;
a second collar that also slides fore and aft causing said retracting tip to take said extended position when moved forward and said retracted position when moved aft.

8. The impact tool socket adapter of claim 7 further comprising a first spring that acts against said first collar and a second spring that acts against said second collar.

9. The impact tool socket adapter of claim 7 wherein said retracting tip is a tip on a pivoting stem, said stem pivoting about a fixed point in said adapter when said second collar is moved fore or aft.

10. The impact tool socket adapter of claim 7 wherein a third spring causes said stem to pivot to a retracted position when said second collar is moved a aft.

11. An impact tool socket adapter having a proximal and distal end comprising:
a cylindrical recess on said proximal end containing a plurality of steel balls or fingers that engage a groove on an impact tool tip groove;
a first collar that slides fore and aft over said cylindrical recess that causes said steel balls or fingers to engage and disengage said groove on said impact tool as it slides;
a first spring that acts against said first collar;
a socket engaging member on said distal end of said adapter containing a retracting tip that locks a socket on said socket engaging member in an extended position and releases said socket in a retracted position;
a second collar that also slides fore and aft causing said retracting tip to take said extended position when moved forward and said retracted position when moved aft;
a second spring that acts against said second collar;
wherein said retracting tip is a tip on a stem, said stem attached to a pivot and pivoting under influence of said second collar;
a third spring acting to pivot said stem to a position where said retracting tip is in said retracted position when said second collar is moved aft.

12. The impact tool socket adapter of claim 11 wherein said adapter, said collars and said balls or fingers are hardened steel.

13. The impact tool socket adapter of claim 11 wherein said socket engaging member is a rectangular solid.

14. The impact tool socket adapter of claim 11 further comprising a plurality of springs that cause said steel balls or fingers to engage said impact tool.
